(19) United States
(12) Patent Application Publication
(10) Pub. No.: US 2024/0161762 A1
(43) Pub. Date: May 16, 2024

(54) FULL-BAND AUDIO SIGNAL RECONSTRUCTION ENABLED BY OUTPUT FROM A MACHINE LEARNING MODEL

(71) Applicant: SHURE ACQUISITION HOLDINGS, INC., Niles, IL (US)

(72) Inventors: Wenshun Tian, Palatine, IL (US); Michael Lester, Buena Vista, CO (US)

(21) Appl. No.: 18/506,510

(22) Filed: Nov. 10, 2023

Related U.S. Application Data
(60) Provisional application No. 63/383,418, filed on Nov. 11, 2022.

(51) Int. Cl. G10L 19/06; G10L 19/02; G10L 25/21

(52) U.S. Cl. CPC G10L 19/06; G10L 19/02; G10L 25/21

(57) ABSTRACT

Techniques are disclosed herein for providing full-band audio signal reconstruction enabled by output from a machine learning model trained based on an audio feature set extracted from a portion of the audio signal. Examples may include generating a model input audio feature set for a first frequency portion of an audio signal defined based on a hybrid audio processing frequency threshold. Examples may also include inputting the model input audio feature set to a machine learning model configured to generate a frequency characteristics output related to the first frequency portion of the audio signal. Examples may also include applying the frequency characteristics output to at least a second frequency portion of the audio signal to generate a reconstructed full-band audio signal.

### CROSS REFERENCE TO RELATED APPLICATIONS

This application claims priority to U.S. Provisional Patent Application No. 63/383,418, titled “FULL-BAND AUDIO SIGNAL RECONSTRUCTION ENABLED BY OUTPUT FROM A MACHINE LEARNING MODEL,” and filed on Nov. 11, 2022, the contents of which are hereby incorporated by reference in their entirety.

### TECHNICAL FIELD

Embodiments of the present disclosure relate generally to audio processing and, more particularly, to systems configured to apply machine learning and digital signal processing to audio signals.

### BACKGROUND

A microphone system may employ one or more microphones to capture audio from an audio environment. However, noise, reverberation and/or other undesirable sound is often introduced during audio capture by a microphone system.

### BRIEF SUMMARY

Various embodiments of the present disclosure are directed to apparatuses, systems, methods, and computer readable media for providing full-band audio signal reconstruction enabled by output from a machine learning model. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example hybrid audio system configured to execute machine learning (ML) and digital signal processing (DSP) operations in accordance with one or more embodiments disclosed herein;

FIG. 2 illustrates an example audio signal processing apparatus configured in accordance with one or more embodiments disclosed herein;

FIG. 3 illustrates an example ML model configured to provide frequency characteristics output in accordance with one or more embodiments disclosed herein;

FIG. 4 illustrates an example hybrid ML/DSP audio processing system that includes a first frequency processing engine and a second frequency processing engine in accordance with one or more embodiments disclosed herein;

FIG. 5A illustrates a graph of magnitude scaling to a first frequency portion of an audio signal defined based on a hybrid audio processing frequency threshold, in accordance with one or more embodiments disclosed herein;

FIG. 5B illustrates a graph resulting from applying a frequency characteristics output to an audio signal in accordance with one or more embodiments disclosed herein;

FIG. 6A illustrates a graph resulting from applying a frequency characteristics output to an audio signal based on an overlapped frequency range, in accordance with one or more embodiments disclosed herein;

FIG. 6B illustrates a graph of a reconstructed full-band audio signal after execution of one or more DSP processes in accordance with one or more embodiments disclosed herein;

FIG. 7 illustrates a spectrogram comparison of an audio signal and a reconstructed full-band audio signal generated through full-band audio reconstruction operations in accordance with one or more embodiments disclosed herein; and

FIG. 8 illustrates an example method for providing hybrid audio signal processing using a combination of machine learning and digital signal processing in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

Various embodiments of the present disclosure address technical problems associated with accurately, efficiently and/or reliably removing or suppressing reverberation, noise, or other undesirable characteristics associated with an audio signal. The disclosed techniques may be implemented by an audio signal processing system to provide improved audio signal quality.

Noise, reverberation, and/or other undesirable audio characteristics are often introduced during audio capture operations related to telephone conversations, video chats, office conferencing scenarios, lecture hall microphone systems, broadcasting microphone systems, augmented reality applications, virtual reality applications, in-ear monitoring systems, sporting events, live performances and music or film production scenarios, etc. Such noise, reverberation, and/or other undesirable audio characteristics affect intelligibility of speech and may produce other undesirable audio experiences for listeners.

Various examples disclosed herein provide an audio signal processing system configured for providing full-band audio signal reconstruction enabled by output from a machine learning model trained based on an audio feature set extracted from a portion of the audio signal. The full-band audio reconstruction may be provided via a combination of machine learning (ML) and digital signal processing (DSP) with respect to an audio signal.

### Exemplary Hybrid ML/DSP Audio Processing Systems and Methods

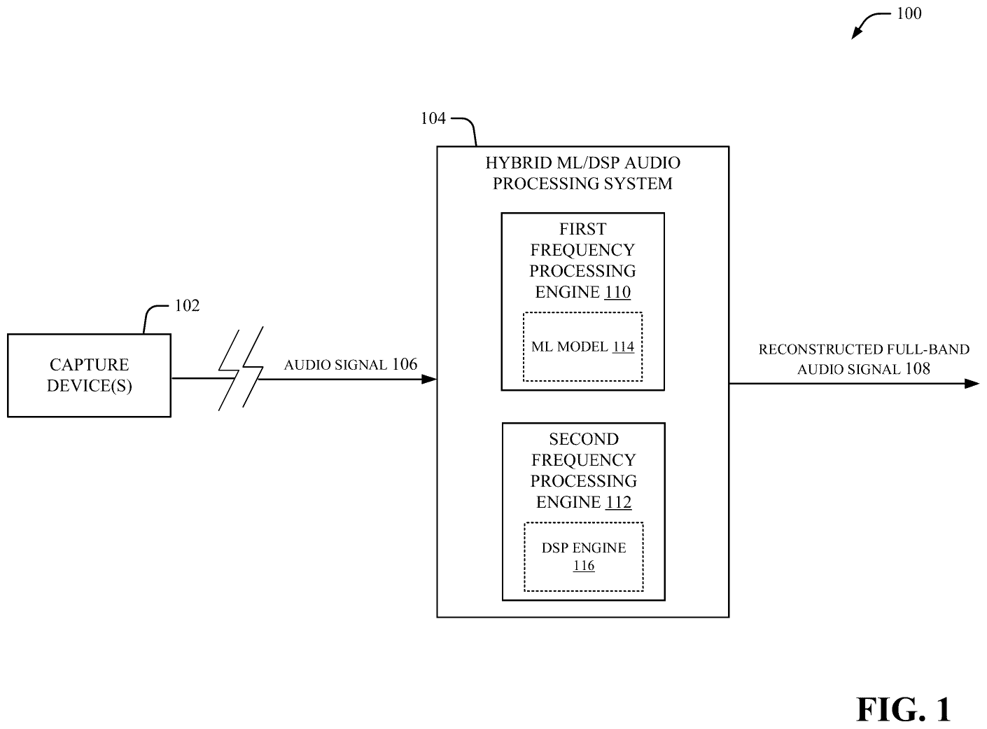

FIG. 1 illustrates an audio signal processing system 100 that is configured to provide full-band audio signal reconstruction of an audio signal, according to embodiments of the present disclosure. The full-band audio signal reconstruction is enabled by output from a machine learning model trained based on an audio feature set extracted from a portion of the audio signal. In some examples, the audio signal processing system 100 may be a hybrid audio processing system that utilizes a combination of ML and DSP with respect to the audio signal. For example, the audio signal processing system 100 may identify a first frequency band or portion of an audio signal and a second frequency band or portion of the audio signal in accordance with a threshold. Then, a trained ML model may be applied to a first frequency band of an audio signal to identify, learn, or extract characteristics that may be applied to at least a second frequency band of the audio signal via DSP operations in order to construct a full-band audio signal. In some examples, the characteristics may be applied to both the first frequency band and the second frequency band. In some examples, the trained ML model may be trained, during a training phase, based on training data extracted from the first frequency band of prior audio signals.

The audio signal processing system 100 may be, for example, a conferencing system (e.g., a conference audio system, a video conferencing system, a digital conference system, etc.), an audio performance system, an audio recording system, a music performance system, a music recording system, a digital audio workstation, a lecture hall microphone systems, a broadcasting microphone system, a sporting event audio system, an augmented reality system, a virtual reality system, an online gaming system, or another type of audio system. Additionally, the audio signal processing system 100 may be implemented as an audio signal processing apparatus and/or as software that is configured for execution on a smartphone, a laptop, a personal computer, a digital conference system, a wireless conference unit, an audio workstation device, an augmented reality device, a virtual reality device, a recording device, headphones, earphones, speakers, or another device. The audio signal processing system 100 disclosed herein may additionally or alternatively be integrated into a virtual DSP processing system (e.g., DSP processing via virtual processors or virtual machines) with other conference DSP processing.

The audio signal processing system 100 may be adapted to produce improved audio signals with reduced noise, reverberation, and/or other undesirable audio artifacts even in view of exacting audio latency requirements. In applications focused on reducing noise, such reduced noise may be stationary and/or non-stationary noise. Additionally, the audio signal processing system 100 may provide improved audio quality for audio signals in an audio environment. An audio environment may be an indoor environment, an outdoor environment, a room, a performance hall, a broadcasting environment, a sports stadium or arena, a virtual environment, or another type of audio environment. In various examples, the audio signal processing system 100 may be configured to remove or suppress noise, reverberation, and/or other undesirable sound from audio signals via a combination of machine learning modeling and digital signal processing.

The audio signal processing system 100 may be configured to remove noise, reverberation and/or other undesirable sound from speech-based audio signals captured within an audio environment. For example, an audio processing system may be incorporated into microphone hardware for use when a microphone is in a “speech” mode. The audio signal processing system 100 may alternatively be employed for another type of sound enhancement application such as, but not limited to, active noise cancelation, adaptive noise cancelation, etc.

Additionally, in some examples, the audio signal processing system 100 may remove noise, reverberation, and/or other audio artifacts from non-speech audio signals such as music, precise audio analysis applications, public safety tools, sporting event audio, or other non-speech audio.

The audio signal processing system 100 comprises one or more capture devices 102. The one or more capture devices 102 may include one or more sensors configured for capturing audio by converting sound into one or more electrical signals. The audio captured by the one or more capture devices 102 may also be converted into an audio signal 106. The audio signal 106 may be a digital audio signal or, alternatively, an analog signal.

In an example, the one or more capture devices 102 are one or more microphones. For example, the one or more capture devices 102 may correspond to one or more condenser microphones, one or more micro-electromechanical systems (MEMS) microphones, one or more dynamic microphones, one or more piezoelectric microphones, one or more array microphones, one or more beamformed lobes of an array microphone, one or more linear array microphones, one or more ceiling array microphones, one or more table array microphones, one or more virtual microphones, one or more network microphones, one or more ribbon microphones, or another type of microphone configured to capture audio. However, it is to be appreciated that, in certain examples, the one or more capture devices 102 may additionally or alternatively include one or more video capture devices, one or more infrared capture devices, one or more sensor devices, and/or one or more other types of audio capture devices. Additionally, the one or more capture devices 102 may be positioned within a particular audio environment.

The audio signal processing system 100 also comprises a hybrid ML/DSP audio processing system 104. The hybrid ML/DSP audio processing system 104 may be configured to perform denoising, dereverberation, and/or other filtering of undesirable sound with respect to the audio signal 106 to provide a reconstructed full-band audio signal 108. The reconstructed full-band audio signal 108 may be a full-band audio version of the audio signal 106 with removed or suppressed noise, reverberation and/or audio artifacts related to undesirable sound. For example, the audio signal 106 may be associated with noisy audio data and the reconstructed full-band audio signal 108 may be associated with denoised audio data. In another example, the audio signal 106 may be associated with reverberated audio data and the reconstructed full-band audio signal 108 may be associated with dereverberated audio data. The dereverberated audio data may include audio with minimized or removed reverberation.

The hybrid ML/DSP audio processing system 104 depicted in FIG. 1 includes a first frequency processing engine 110 and a second frequency processing engine 112. The first frequency processing engine 110 includes a machine learning (ML) model 114 and the second frequency processing engine 112 includes a DSP engine 116. The first frequency processing engine 110 and the second frequency processing engine 112 may be configured to respectively process one or more portions of the audio signal 106 and/or to provide full-band audio reconstruction of the audio signal 106 while also providing the denoising, dereverberation, and/or other filtering of undesirable sound.

The hybrid ML/DSP audio processing system 104 is configured to produce a reconstructed full-band audio signal 108 via one or more machine learning operations applied via the first frequency processing engine 110 and digital signal processing operations applied via the second frequency processing engine 112. For example, the depicted first frequency processing engine 110 is configured to apply the ML model 114 to a portion of the audio signal 106 below a hybrid audio processing frequency threshold that will be discussed in greater detail below. The depicted second frequency processing engine 112 is configured to apply digital signal processing to one or more other portions of the audio signal 106 using the DSP engine 116.

The first frequency processing engine 110 may perform the machine learning with respect to a first frequency portion for the audio signal 106 and the second frequency processing engine 112 may perform the digital signal processing with respect to a second frequency portion for the audio signal 106. The first frequency portion may be a range or interval of frequency such as, for example, a particular frequency band for the audio signal 106. The second frequency portion may be a different range or interval of frequency such as, for example, a different frequency band for the audio signal 106 that is distinct from the first frequency audio portion. For example, the first frequency processing engine 110 may apply the ML model 114 to a lower frequency band of the audio signal 106 (e.g., a first frequency portion defined below a hybrid audio processing frequency threshold) and the second frequency processing engine 112 may apply digital signal processing to a higher frequency band of the audio signal 106 (e.g., a second frequency portion defined above the hybrid audio processing frequency threshold). The applied digital signal processing operations may be informed by frequency characteristics (e.g., frequency characteristics output) determined by the ML model 114 applied by first frequency processing engine 110.

The ML model 114 may be trained based on a particular hybrid audio processing frequency threshold to identify, learn, or extract characteristics for a frequency portion or frequency band below or above the particular hybrid audio processing frequency threshold. In some examples, the ML model 114 is trained during one or more training phases based on training data extracted from frequency portions of prior audio signals. In some examples, the ML model 114 may be repeatedly trained during a plurality of training phases until the identified, learned, or extracted characteristics satisfy quality criterion for denoising, dereverberation, filtering, or other audio processing. The frequency portions of the prior audio signals may correspond to frequencies below or above the particular hybrid audio processing frequency threshold. For example, the frequency portions of the prior audio signals may correspond to frequencies of the first frequency portion for the audio signal 106.

In some examples, the first frequency processing engine 110 may apply the ML model 114 to a higher frequency band for the audio signal 106 (e.g., a first frequency portion defined above a hybrid audio processing frequency threshold) and the second frequency processing engine 112 may apply digital signal processing to a lower frequency band for the audio signal 106 (e.g., a second frequency portion defined below the hybrid audio processing frequency threshold).

The first frequency processing engine 110 may apply the ML model 114 to the first frequency portion of the audio signal 106 to determine characteristics that may be used in digital signal processing operations applied to a second frequency portion of the audio signal 106 via the second frequency processing engine 112. The characteristics learned from application of the ML model 114 may include, for example, audio characteristics, frequency-based characteristics, temporal characteristics, magnitude characteristics, attenuation characteristics, denoising characteristics, dereverberation characteristics, filtering characteristics, generative audio characteristics, and/or other characteristics. Such characteristics may be aggregated and structured as frequency characteristics output as discussed in greater detail below.

Accordingly, denoising, dereverberation, and/or other filtering of undesirable sound may be performed using the ML model 114 with respect to a certain audio spectrum segment of the audio signal 106 (e.g., a statistically and/or perceptually important audio spectrum segment of the audio signal 106) and the characteristics learned via the ML model 114 may be adaptively added through DSP operations to a remaining audio spectrum segment of the audio signal 106. Therefore, in contrast to traditional audio processing techniques that might perform digital signal processing with respect to an entire frequency range of an audio signal, various embodiments discussed herein use machine learning applied to a selected audio spectrum segment of an audio signal to extract characteristics and information that may be used in DSP operations that are applied more broadly to the remainder of the audio signal. Such embodiments provide improved computational efficiencies and/or reduced bandwidth consumption as compared to traditional audio processing.

The hybrid ML/DSP audio processing system 104 may be adapted to produce improved audio signals with reduced noise, reverberation, and/or other undesirable audio artifacts even in view of exacting audio latency requirements. In applications focused on reducing noise, such reduced noise may be stationary and/or non-stationary noise.

The characteristics learned by the machine learning 114 may also provide deeper temporal features and/or higher frequency resolutions as compared to traditional full-band processing of an audio signal. The characteristics learned by the ML model 114 may also enable the hybrid audio processing operations disclosed herein to provide improved computational efficiency by performing audio processing at a lower sample rate (e.g., less than 24 kHz) while producing full-band audio (e.g., 24 kHz) with removed or suppressed noise, reverberation, and/or other undesirable sound.

In various examples, undesirable sound reflections at a lower frequency range and at a defined bandwidth (e.g., 8 kHz) may be efficiently removed and a full-band audio signal (e.g., 48 kHz) may be reconstructed by adding a particular audio band signal extracted from raw audio to one or more other audio band signals. Accordingly, reconstructed full-band audio may be provided to a user without the undesirable sound reflections. The hybrid ML/DSP audio processing system 104 may also improve runtime efficiency of full-band denoising, dereverberation, and/or other audio filtering while also maximizing full-band audio for an original audio spectrum of the audio signal 106.

Moreover, the hybrid ML/DSP audio processing system 104 may employ fewer of computing resources when compared to traditional audio processing systems that are used for digital signal processing. Additionally or alternatively, in one or more embodiments, the hybrid ML/DSP audio processing system 104 may be configured to deploy a smaller number of memory resources allocated to denoising, dereverberation, and/or other audio filtering for an audio signal sample such as, for example, the audio signal 106. In still other embodiments, the hybrid ML/DSP audio processing system 104 may be configured to improve processing speed of denoising operations, dereverberation operations, and/or audio filtering operations. The hybrid ML/DSP audio processing system 104 may also be configured to reduce a number of computational resources associated with applying machine learning models such as, for example, the ML model 114, to the task of denoising, dereverberation, and/or audio filtering. These improvements enable, in some embodiments, for an improved audio processing systems to be deployed in microphones or other hardware/software configurations where processing and memory resources are limited, and/or where processing speed and efficiency is important.

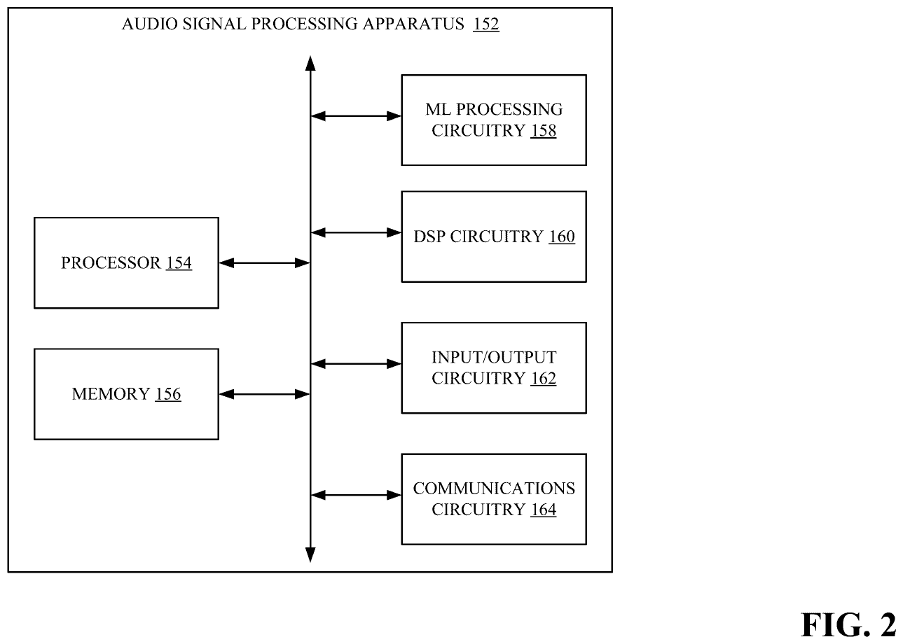

FIG. 2 illustrates an example audio signal processing apparatus 152 configured in accordance with one or more embodiments of the present disclosure. The audio signal processing apparatus 152 may be configured to perform one or more techniques described in FIG. 1 and/or one or more other techniques described herein. In one or more embodiments, the audio signal processing apparatus 152 may be embedded in the hybrid ML/DSP audio processing system 104.

In some cases, the audio signal processing apparatus 152 may be a computing system communicatively coupled with, and configured to control, one or more circuit modules associated with wireless audio processing. For example, the audio signal processing apparatus 152 may be a computing system and/or a computing system communicatively coupled with one or more circuit modules related to wireless audio processing. The audio signal processing apparatus 152 may comprise or otherwise be in communication with a processor 154, a memory 156, ML processing circuitry 158, DSP processing circuitry 160, input/output circuitry 162, and/or communications circuitry 164. In some embodiments, the processor 154 (which may comprise multiple or co-processors or any other processing circuitry associated with the processor) may be in communication with the memory 156.

The memory 156 may comprise non-transitory memory circuitry and may comprise one or more volatile and/or non-volatile memories. In some examples, the memory 156 may be an electronic storage device (e.g., a computer readable storage medium) configured to store data that may be retrievable by the processor 154. In some examples, the data stored in the memory 156 may comprise radio frequency signal data, audio data, stereo audio signal data, mono audio signal data, or the like, for enabling the apparatus to carry out various functions or methods in accordance with embodiments of the present invention, described herein.

In some examples, the processor 154 may be embodied in a number of different ways. For example, the processor 154 may be embodied as one or more of various hardware processing means such as a central processing unit (CPU), a microprocessor, a coprocessor, a digital signal processor (DSP), an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 154 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor 154 may comprise one or more processing cores configured to perform independently. A multi-core processor may enable multiprocessing within a single physical package. Additionally or alternatively, the processor 154 may comprise one or more processors configured in tandem via the bus to enable independent execution of instructions, pipelining, and/or multithreading.

In some examples, the processor 154 may be configured to execute instructions, such as computer program code or instructions, stored in the memory 156 or otherwise accessible to the processor 154. Alternatively or additionally, the processor 154 may be configured to execute hard-coded functionality. As such, whether configured by hardware or software instructions, or by a combination thereof, the processor 154 may represent a computing entity (e.g., physically embodied in circuitry) configured to perform operations according to an embodiment of the present invention described herein. For example, when the processor 154 is embodied as an CPU, DSP, ARM, FPGA, ASIC, or similar, the processor may be configured as hardware for conducting the operations of an embodiment of the invention. Alternatively, when the processor 154 is embodied to execute software or computer program instructions, the instructions may specifically configure the processor 154 to perform the algorithms and/or operations described herein when the instructions are executed. However, in some cases, the processor 154 may be a processor of a device specifically configured to employ an embodiment of the present invention by further configuration of the processor using instructions for performing the algorithms and/or operations described herein. The processor 154 may further comprise a clock, an arithmetic logic unit (ALU) and logic gates configured to support operation of the processor 154, among other things.

In some examples, the audio signal processing apparatus 152 may comprise the ML processing circuitry 158. The ML processing circuitry 158 may be any means embodied in either hardware or a combination of hardware and software that is configured to perform one or more functions disclosed herein related to machine learning. Additionally, the ML processing circuitry 158 may correspond to the first frequency processing engine 110 and/or may perform one or more functions associated with the first frequency processing engine 110. In one or more embodiments, the audio signal processing apparatus 152 may comprise the DSP processing circuitry 160. The DSP processing circuitry 160 may be any means embodied in either hardware or a combination of hardware and software that is configured to perform one or more functions disclosed herein related to digital signal processing. Additionally, the DSP processing circuitry 160 may correspond to the second frequency processing engine 112 (and/or the DSP engine 116) and/or may perform one or more operations associated with the second frequency processing engine 112 (and/or the DSP engine 116).

In some examples, the audio signal processing apparatus 152 may comprise the input/output circuitry 162 that may, in turn, be in communication with processor 154 to provide output to the user and, in some embodiments, to receive an indication of a user input. The input/output circuitry 162 may comprise a user interface and may comprise a display. In some embodiments, the input/output circuitry 162 may also comprise a keyboard, a touch screen, touch areas, soft keys, buttons, knobs, or other input/output mechanisms.

In some examples, the audio signal processing apparatus 152 may comprise the communications circuitry 164. The communications circuitry 164 may be any means embodied in either hardware or a combination of hardware and software that is configured to receive and/or transmit data from/to a network and/or any other device or module in communication with the audio signal processing apparatus 152. In this regard, the communications circuitry 164 may comprise, for example, an antennae or one or more other communication devices for enabling communications with a wired or wireless communication network. For example, the communications circuitry 164 may comprise antennae, one or more network interface cards, buses, switches, routers, modems, and supporting hardware and/or software, or any other device suitable for enabling communications via a network. Additionally or alternatively, the communications circuitry 164 may comprise the circuitry for interacting with the antenna/antennae to cause transmission of signals via the antenna/antennae or to handle receipt of signals received via the antenna/antennae.

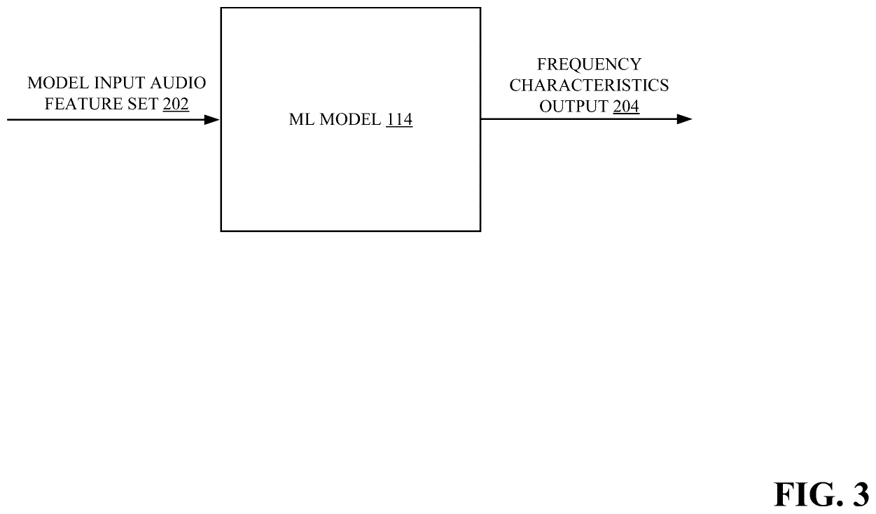

FIG. 3 further illustrates an example ML model 114 that is configured to provide machine learning associated with the first frequency processing engine 110 according to one or more embodiments of the present disclosure. The depicted ML model 114 may receive a model input audio feature set 202 associated with the audio signal 106. The model input audio feature set 202 may include one or more model input audio features for the first frequency portion of the audio signal 106. The model input audio features may represent physical features and/or perceptual features related to the first frequency portion of the audio signal 106. For instance, the one or more model input audio features may comprise: one or more: audio spectrum features, magnitude features, phase features, pitch features, harmonic features, Mel-frequency cepstral coefficients (MFCC) features, performance features, performance sequencer features, tempo features, time signature features, and/or other types of features associated with the first frequency portion of the audio signal 106.

The magnitude features may represent physical features of the first portion of the audio signal 106 such as magnitude measurements with respect to the first frequency portion of the audio signal 106. The phase features may represent physical features of the first portion of the audio signal 106 such as phase measurements with respect to the first frequency portion of the audio signal 106. The pitch features may represent perceptual features of the first portion of the audio signal 106 such as frequency characteristics related to pitch for the first frequency portion of the audio signal 106. The harmonic features may represent perceptual features of the first portion of the audio signal 106 such as frequency characteristics related to harmonics for the first frequency portion of the audio signal 106.

The MFCC features may represent physical features of the first portion of the audio signal 106 such as MFCC measurements with respect to the first frequency portion of the audio signal 106. The MFCC measurements may be extracted based on windowing operations, digital transformations, and/or warping of frequencies on a Mel frequency scale with respect to the first frequency portion of the audio signal 106.

The performance features may represent perceptual features of the first portion of the audio signal 106 such as audio characteristics related to performance of the first frequency portion of the audio signal 106. In various embodiments, the performance features may be obtained via one or more audio analyzers that analyze performance of the first frequency portion of the audio signal 106. The performance sequencer features may represent perceptual features of the first portion of the audio signal 106 such as audio characteristics related to performance of the first frequency portion of the audio signal 106 as determined by one or more audio sequencers that analyze characteristics of the first frequency portion of the audio signal 106.

The tempo features may represent perceptual features of the first portion of the audio signal 106 such as beats per minute characteristics related to tempo for the first frequency portion of the audio signal 106. The time signature features may represent perceptual features of the first portion of the audio signal 106 such as beats per musical measure characteristics related to a time signature for the first frequency portion of the audio signal 106.

The first frequency portion of the audio signal 106 and/or the second frequency portion of the audio signal 106 may be defined based on a hybrid audio processing frequency threshold. Additionally or alternatively, the first frequency portion of the audio signal 106 may correspond to a first frequency band (e.g., a first audio frequency band) of the audio signal 106 and the second frequency portion of the audio signal 106 may correspond to a second frequency band (e.g., a second audio frequency band) of the audio signal 106. The model input audio feature set 202 may also be formatted for processing by the ML model 114.

In one example, the hybrid audio processing frequency threshold corresponds to 500 Hz or approximately 500 Hz. In another example, the hybrid audio processing frequency threshold corresponds to 4 kHz or approximately 4 kHz. In yet another example, the hybrid audio processing frequency threshold corresponds to 8 kHz or approximately 8 kHz. However, it is to be appreciated that the hybrid audio processing frequency threshold may correspond to a different frequency value. In some examples, the hybrid audio processing frequency threshold may be defined based on a type of audio processing (e.g., denoising, dereverberation, etc.) or filtering to be applied to the audio signal 106.

In some examples, the first frequency processing engine 110 may generate the model input audio feature set 202 based on a digital transform of the first frequency portion of the audio signal 106. For example, the first frequency processing engine 110 may generate the model input audio feature set 202 based on a digital transform of audio data below or above the hybrid audio processing frequency threshold. The digital transform may be associated with a Fourier transform representation, a wavelet audio representation, or another type of audio transformation representation for audio data below or above the hybrid audio processing frequency threshold. The hybrid audio processing frequency threshold of examples herein is a threshold that defines an upper boundary (although a lower boundary may be defined in accordance with alternate examples herein described) for a frequency portion or frequency band of the audio signal 106 that is to be processed via machine learning. The depicted feature extraction 302 is configured to employ one or more filtering techniques associated with downsampling to provide the model input audio feature set 202.

The first frequency processing engine 110 may select the hybrid audio processing frequency threshold from a plurality of hybrid audio processing frequency thresholds based on a type of audio processing associated with the ML model 114. The plurality of hybrid audio processing frequency thresholds may include respective predetermined hybrid audio processing frequency thresholds that correspond to respective types of audio processing for audio reconstruction. For example, depending upon the desired audio processing for audio reconstruction, the plurality of hybrid audio processing frequency thresholds may include one or more thresholds associated with: denoising, dereverberation, wideband speech communication, and/or another type of audio reconstruction. That is, for example, if the desired audio processing for audio reconstruction includes denoising, the hybrid audio processing frequency threshold is defined in accordance with denoising. Alternatively, for example, if the desired audio processing for audio reconstruction includes dereverberation, the hybrid audio processing frequency threshold is defined in accordance with dereverberation.

In examples where the first frequency processing engine 110 applies the ML model 114 to a lower frequency band for the audio signal 106 and the second frequency processing engine 112 applies digital signal processing to a higher frequency band for the audio signal 106, the hybrid audio processing frequency threshold may correspond to 8 kHz such that the first frequency portion of the audio signal 106 associated with processing by the ML model 114 corresponds to a 0 kHz-8 kHz frequency range and the second frequency portion of the audio signal 106 associated with DSP processing corresponds to an 8 kHz-24 kHz (or optionally 8 kHz-16 kHz) frequency range. In another example where the first frequency processing engine 110 applies the ML model 114 to a lower frequency band for the audio signal 106 and the second frequency processing engine 112 applies digital signal processing to a higher frequency band for the audio signal 106, the hybrid audio processing frequency threshold may correspond to 4 kHz such that the first frequency portion of the audio signal 106 associated with processing by the ML model 114 corresponds to a 0 kHz-4 kHz frequency range and the second frequency portion of the audio signal 106 associated with DSP processing corresponds to a 4 kHz-8 kHz frequency range.

In yet another example where the first frequency processing engine 110 applies the ML model 114 to a higher frequency band for the audio signal 106 and the second frequency processing engine 112 applies digital signal processing to a lower frequency band for the audio signal 106, the hybrid audio processing frequency threshold may correspond to 500 Hz such that the first frequency portion of the audio signal 106 associated with processing by the ML model 114 corresponds to a 500 Hz-4 kHz (or optionally 500 Hz-8 kHz) frequency range and the second frequency portion of the audio signal 106 associated with DSP processing corresponds to a 0 Hz-500 Hz. However, it is to be appreciated that, in other example embodiments, the hybrid audio processing frequency threshold may correspond to a different frequency value depending the type of desired audio processing, audio environment characteristics, and other factors that will be apparent to one of ordinary skill in the art in view of this disclosure.

In some examples, the ML model 114 may be configured as a set of ML models each respectively preconfigured and trained based on different hybrid audio processing frequency thresholds. For example, the ML model 114 may be configured as at least a first ML model configured based on a first hybrid audio processing frequency threshold and a second ML model configured based on a second hybrid audio processing frequency threshold different than the first hybrid audio processing frequency threshold. During real-time operation of the hybrid ML/DSP audio processing system 104 of such embodiments, the first frequency processing engine 110 may dynamically select either the first ML model or the second ML model. The first frequency processing engine 110 may select the first ML model or the second ML model based on environment conditions associated with an audio environment, user feedback based on preconfigured audio environment options, information related to the one or more capture devices 102, detected noise or reverberation characteristics, and/or other information related to the audio signal 106.

The ML model 114 may be a deep neural network (DNN) model, a generative adversarial network (GAN) model (e.g., a diffusion-based GAN), a recurrent neural network (RNN), or another type of machine learning model associated with machine learning or deep learning. Alternatively, the ML model 114 may be a DSP model such as, for example, a statistical-based model, associated with digital signal processing modeling. In some examples, the ML model 114 may be a U-NET-based neural network model. The ML model 114 may be is configured for denoising audio processing, dereverberation audio processing, and/or another type of audio processing for audio reconstruction. For example, the ML model 114 may be trained to provide denoising, dereverberation, and/or another type of audio processing for a defined frequency range.

Based on the model input audio feature set 202, the depicted ML model 114 is configured to generate a frequency characteristics output 204. The frequency characteristics output 204 may be related to the first frequency portion of the audio signal 106. For example, the frequency characteristics output 204 may be configured based on frequency characteristics of the first frequency portion of the audio signal 106 as determined by the ML model 114. The frequency characteristics output 204 may also provide frequency characteristic predictions for the first frequency portion of the audio signal 106. The frequency characteristic predictions may be related to scaling of magnitude and/or other frequency characteristic modifications to provide denoising, dereverberation, and/or other filtering of undesirable sound associated with the frequency portion of the audio signal 106.

In some examples, the ML model 114 may convert a magnitude of the first frequency portion of the audio signal 106 to a scaled magnitude based on the model input audio feature set 202. For example, magnitude characteristics for the first frequency portion of the audio signal 106 may be scaled to provide denoising, dereverberation, and/or other filtering of undesirable sound associated with the frequency portion of the audio signal 106. The magnitude characteristics may comprise one or more of: amplitude, decibel values, dynamic range, spectral content, and/or one or more other magnitude characteristics. In certain examples, the ML model 114 may modify the first frequency portion of the audio signal 106 based on a scaling technique associated with perceptually weighted magnitudes and/or critical band perception.

The frequency characteristics output 204 may be related to frequency characteristics, magnitude characteristics, phase characteristics, latency characteristics, and/or one or more other characteristics associated with predictions for the first frequency portion of the audio signal 106. The frequency characteristics output 204 may be a prediction-based output provided by the ML model 114. Additionally or alternatively, the frequency characteristics output 204 may be an output mask provided by the ML model 114.

In some examples, the frequency characteristics output 204 may be a neural network noise mask provided by the ML model 114. In another embodiment, the frequency characteristics output 204 may be a neural network reverberation mask provided by the ML model 114. However, it is to be appreciated that, in certain embodiments, the frequency characteristics output 204 may be a different type of neural network mask to facilitate filtering of undesirable audio artifacts associated with the first frequency portion of the audio signal 106.

The frequency characteristics output 204 may be a “soft” mask that includes a set of values that identify noise, reverberation, and/or undesirable sound in the first frequency portion of the audio signal 106. For instance, an example frequency characteristics output 204 may be a soft mask that provides a set of values ranging from 0 to 1 that correspond to weighted values associated with a degree of noise, reverberation, and/or undesirable sound in the first frequency portion of the audio signal 106.

In some examples, the frequency characteristics output 204 may be a time-frequency mask associated with frequency characteristic predictions for the first frequency portion of the audio signal 106. The time-frequency mask refers to a neural network mask that represents masking applied to the first frequency portion of the audio signal 106 based on frequency and time. The frequency characteristics output 204 may additionally or alternately be formatted as a spectrogram that provides a set of values ranging from 0 to 1 for the first frequency portion of the audio signal 106. The spectrogram may be formatted based on frequency and time.

Referring back to FIG. 1, the second frequency processing engine 112 may be configured to apply the frequency characteristics output 204 to the audio signal 106. In one or more embodiments, the second frequency processing engine 112 may apply the frequency characteristics output 204 to at least a second frequency portion, different than the first frequency portion, to generate the reconstructed full-band audio signal 108. For example, the DSP engine 116 of the second frequency processing engine 112 may apply the frequency characteristics output 204 to at least the second frequency portion of the audio signal using one or more digital signal processing techniques.

The second frequency processing engine 112 may apply the frequency characteristics output 204 to the second frequency portion of the audio signal 106 to generate digitized audio data. Additionally, the second frequency processing engine 112 may transform the digitized audio data into a time domain format to generate the reconstructed full-band audio signal 108. The time domain format may represent the reconstructed full-band audio signal 108 in the time domain such as, for example, via a waveform associated with amplitude and time.

To provide improved reconstruction of full-band audio related to the first frequency portion and the second frequency portion of the audio signal 106, the second frequency processing engine 112 may calculate a spectrum power ratio for an overlapped frequency range proximate to the hybrid audio processing frequency threshold. The spectrum power ratio may indicate a distribution or degree of power across the overlapped frequency range. In some examples, the spectrum power ratio may be a ratio of total power in a frequency band to total power in the audio signal. The overlapped frequency range proximate to the hybrid audio processing frequency threshold may include a sub-portion of the first frequency portion and a sub-portion of the second frequency portion. Additionally, the second frequency processing engine 112 may apply the frequency characteristics output 204 to the audio signal 106 based on the spectrum power ratio. Accordingly, improved audio quality may be provided for a portion of an audio signal proximate to the hybrid audio processing frequency threshold and/or within the overlapped frequency range.

In various examples, the reconstructed full-band audio signal 108 may be transmitted to respective output channels for further audio signal processing and/or output via an audio output device such as, but not limited to, a listening device, a digital conference system, a wireless conference unit, an audio workstation device, an augmented reality device, a virtual reality device, a recording device, or another type of audio output device. In some examples, a listening device includes headphones, earphones, speakers, or another type of listening device. The reconstructed full-band audio signal 108 may additionally or alternatively be transmitted to one or more subsequent digital signal processing stages and/or one or more subsequent machine learning processes.

In various examples, the reconstructed full-band audio signal 108 may also be configured for reconstruction by one or more receivers. For example, the reconstructed full-band audio signal 108 may be configured for one or more receivers associated with a teleconferencing system, a video conferencing system, a virtual reality system, an online gaming system, a metaverse system, a recording system, and/or another type of system. In certain embodiments, the one or more receivers may be one or more far-end receivers configured for real-time spatial scene reconstruction. Additionally, the one or more receivers may be one or more codecs configured for teleconferencing, videoconferencing, one or more virtual reality applications, one or more online gaming applications, one or more recording applications, and/or one or more other types of codecs.

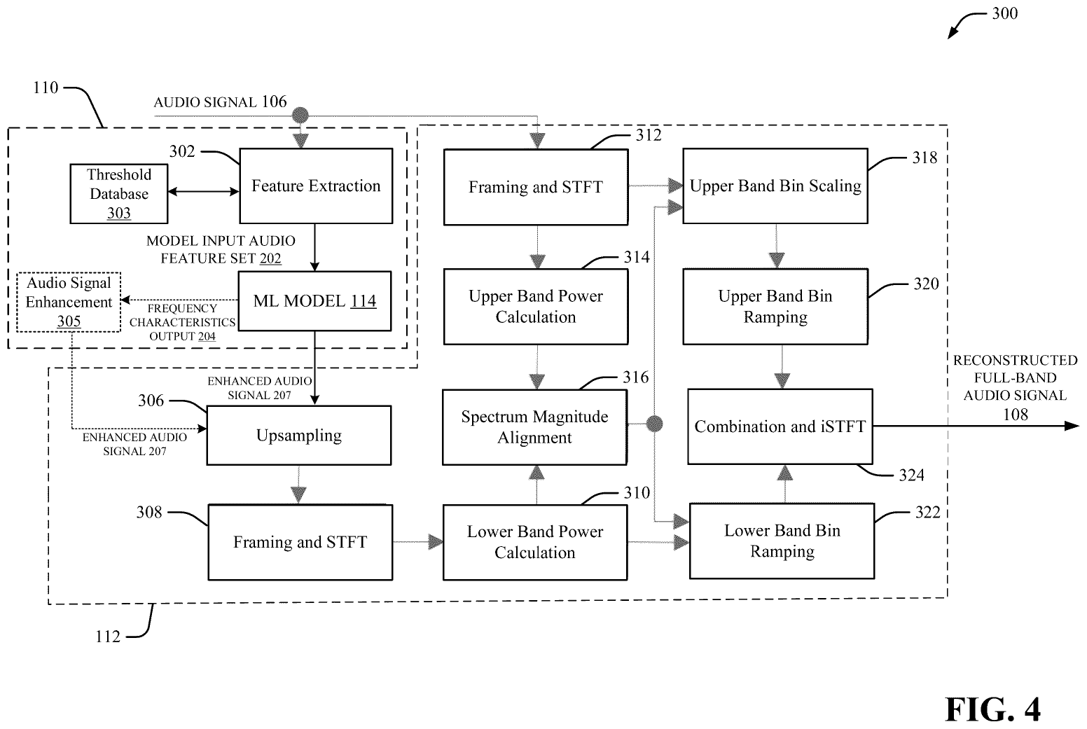

FIG. 4 illustrates a hybrid ML/DSP audio processing system 300 for audio processing enabled by the first frequency processing engine 110 and the second frequency processing engine 112 of FIG. 1 according to one or more embodiments of the present disclosure. The depicted hybrid ML/DSP audio processing system 300 includes feature extraction 302, the ML model 114, audio signal enhancement 305, upsampling 306, framing and short-term Fourier transform (STFT) 308, lower band power calculation 310, framing and STFT 312, upper band power calculation 314, spectrum magnitude alignment 316, upper band bin scaling 318, upper band bin ramping 320, lower band bin ramping 322, and/or combination and inverse STFT (iSTFT) 324. The feature extraction 302, the audio signal enhancement 305, the upsampling 306, the framing and STFT 308, the lower band power calculation 310, the framing and STFT 312, the upper band power calculation 314, the spectrum magnitude alignment 316, the upper band bin scaling 318, the upper band bin ramping 320, the lower band bin ramping 322, and/or the combination iSTFT 324 may be respective modules (e.g., circuit modules) representing respective operations performed in series and/or in parallel.

The first frequency processing engine 110 illustrated in FIG. 1 may include at least the feature extraction 302, the ML model 114 and/or the audio signal enhancement 305. The feature extraction 302 module is configured to receive the audio signal 106 as a full-band signal (e.g., 48 kHz sampling rate) and convert the audio signal 106 into a low-bandwidth signal (e.g., 16 kHz sampling rate) via one or more downsampling techniques. Additionally, the feature extraction 302 module may extract one or more features related to the low-bandwidth signal to determine the model input audio feature set 202. The model input audio feature set 202 may then be provided to the ML model 114. In one or more embodiments, the model input audio feature set 202 may include one or more features related to the first frequency portion of the audio signal 106. Additionally or alternatively, the model input audio feature set 202 may be configured in a format suitable for input into or application of the ML model 114.

The feature extraction 302 may also employ threshold database 303 to determine a hybrid audio processing frequency threshold for determining the model input audio feature set 202. For example, the feature extraction 302 module may select a hybrid audio processing frequency threshold from a set of predefined hybrid audio processing thresholds to determine a range of frequency values for the first frequency portion of the audio signal 106. The threshold database 303 may alternatively be configured with a predefined hybrid audio processing frequency threshold. In another embodiment, the feature extraction 302 module may dynamically determine the hybrid audio processing frequency threshold based on a filtering mode setting or characteristics of the audio signal 106.

The ML model 114 may employ the model input audio feature set 202 to generate the frequency characteristics output 204 and to generate an enhanced audio signal 207. The enhanced audio signal 207 may be, for example, a low-bandwidth signal version of the audio signal 106 associated with denoising, dereverberation, filtering and/or other modification.

In some examples, the ML model 114 may apply the frequency characteristics output 204 to at least a portion of the audio signal 106 to provide the enhanced audio signal 207. For example, the ML model 114 may apply the frequency characteristics output 204 to the audio signal 106 including a second frequency portion different than the first frequency portion associated with processing by the ML model 114. In an alternate embodiment, the ML model 114 may be a prediction-based model that applies frequency characteristics of the first frequency portion of the audio signal 106 as determined by the ML model 114 to the audio signal 106 to provide the enhanced audio signal 207.

In some examples, the ML model 114 may provide the frequency characteristics output 204 to the audio signal enhancement 305 to apply the frequency characteristics output 204 to at least a portion of the audio signal 106 in order to generate the enhanced audio signal 207. The audio signal enhancement 305 may be implemented separate from the ML model 114. In certain embodiments, the frequency characteristics output 204 may be configured as a frequency characteristics mask output. For example, the ML model 114 or the audio signal enhancement 305 may apply a frequency characteristics mask output to at least a portion of the audio signal 106 in order to provide the enhanced audio signal 207. Additionally, the ML model 114 or the audio signal enhancement 305 may employ one or more mask application techniques to apply the frequency characteristics output 204 to at least a portion of the audio signal 106.

The upsampling 306 may increase a sampling rate of the enhanced audio signal 207 (e.g., the low-bandwidth signal version of the audio signal) to generate a processed version of the audio signal 106 associated with full-band audio. The depicted second frequency processing engine 112 includes at least the upsampling 306, the framing and STFT 308, the lower band power calculation 310, the framing and STFT 312, the upper band power calculation 314, the spectrum magnitude alignment 316, the upper band bin scaling 318, the upper band bin ramping 320, the lower band bin ramping 322, and/or the combination and iSTFT 324.

In various examples, the upsampling 306, the framing and STFT 308, the lower band power calculation 310, the framing and STFT 312, the upper band power calculation 314, the spectrum magnitude alignment 316, the upper band bin scaling 318, the upper band bin ramping 320, the lower band bin ramping 322, and/or the combination and iSTFT 324 may correspond to the DSP engine 116. It is also to be appreciated that, in certain embodiments, the second frequency processing engine 112 and/or the DSP engine 116 may additionally or alternatively include one or more other modules associated with perceptually weighted magnitude alignment, phase alignment, and/or one or more other types of DSP techniques.

The processed version of the audio signal 106 may be a time-domain signal and the framing and STFT 308 may convert the time-domain signal into respective frequency-domain bins. Based on the processed version of the audio signal 106, the second frequency processing engine 112 is configured to perform one or more digital signal processing techniques to generate the reconstructed full-band audio signal 108. In an aspect, the lower band power calculation 310 may calculate an average power for an overlapped frequency range proximate to the hybrid audio processing frequency threshold (e.g., 8 kHz) that distinguishes the first frequency portion and the second frequency portion of the audio signal 106. For example, the lower band power calculation 310 may calculate the averaged power crossing the overlapped frequency range (e.g., 5 kHz to 8 kHz) for the first frequency portion.

Additionally, the framing and STFT 312 may convert an unprocessed version of the audio signal 106 into respective frequency-domain bins and the upper band power calculation 314 may calculate the averaged power crossing the overlapped frequency range (e.g., 5 kHz to 8 kHz) for the second frequency portion. The lower band power calculation 310 and/or the upper band power calculation 314 may be respectively configured to perform a root mean square (RMS) power calculation or another type of power calculation.

The spectrum magnitude alignment 316 may calculate scaling gain for the second frequency portion (e.g., an upper frequency band of the audio signal 106) based on a ratio (e.g., a spectrum power ratio) between the average power for the first frequency portion and the average power for the second frequency portion. The upper band bin scaling 318 may apply attenuation gain to respective frequency-domain bins associated with the unprocessed version of the audio signal 106. The spectrum magnitude alignment 316 may additionally or alternatively be configured for phase alignment, latency alignment, and/or one or more other spectrum alignment techniques.

The upper band bin ramping 320 is configured to apply windowed upper band bins ramping up to the respective frequency-domain bins associated with the unprocessed version of the audio signal 106. Additionally, the lower band bin ramping 322 is configured to apply windowed lower band bins ramping down to the respective frequency-domain bins associated with the processed version of the audio signal 106. The upper band bin ramping 320 and the lower band bin ramping 322 may be applied proximate to the hybrid audio processing frequency threshold.

The degree of ramping provided by the upper band bin ramping 320 and/or the lower band bin ramping 322 may be based on a size of an overlapped frequency range defined proximate to the hybrid audio processing frequency threshold. For example, a number of data bins and/or size of the data bins may be configured for the upper band bin ramping 320 and/or the lower band bin ramping 322 based on a size of an overlapped frequency range defined proximate to the hybrid audio processing frequency threshold.

The combination and iSTFT 324 may combine the respective frequency-domain bins associated with the unprocessed version of the audio signal 106 and the processed version of the audio signal 106 to form digitized audio data. The digitized audio data may be, for example, a Fast Fourier Transform (FFT) data block associated with respective frequency-domain bins for the unprocessed version of the audio signal 106 and the processed version of the audio signal 106. Additionally, the combination and iSTFT 324 may transform the digitized audio data into the reconstructed full-band audio signal 108 configured in a time domain format. The combination and iSTFT 324 may transform the digitized audio data into the reconstructed full-band audio signal 108 using, for example, one or more iSTFT techniques.

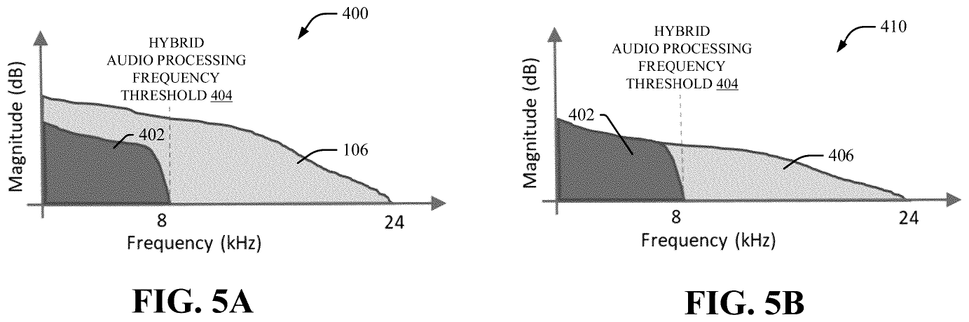

FIG. 5A depicts a graph 400 resulting from magnitude scaling applied to a first frequency portion of an audio signal defined based on a hybrid audio processing frequency threshold, according to one or more embodiments of the present disclosure. The depicted graph 400 includes a spectrum (e.g., magnitude versus frequency) representation of the audio signal 106 and magnitude scaling of the first frequency portion 402 based on the ML model 114. The portion of the audio signal 106 below a hybrid audio processing frequency threshold 404 may correspond to the first frequency portion 402 and may correspond to a portion of the audio signal 106 that undergoes processing via the ML model 114. In some examples, the hybrid audio processing frequency threshold 404 corresponds to a particular frequency value within a range of 500 Hz and 8 kHz.

FIG. 5B depicts a graph 410 resulting from the application of a frequency characteristics output to an audio signal, according to one or more embodiments of the present disclosure. The graph 410 depicts the first frequency portion 402 that undergoes processing by the ML model 114. The graph 410 also includes a spectrum (e.g., magnitude versus frequency) representation of the reconstructed full-band audio signal 108 after applying a frequency characteristics output to the audio signal 106. The graph 410 may also include a magnitude versus frequency representation of the reconstructed full-band audio signal 108 after applying gain scaling to the audio signal 106 based on the frequency characteristics output. For example, the frequency characteristics output 204 generated by the ML model 114 may be applied to the audio signal 106 to scale the audio signal 106 based on frequency characteristics of the first frequency portion 402 and to provide a processed audio signal 406.

In some examples, attenuation gain may be applied to the audio signal 106 based on learned characteristics of the first frequency portion 402 to provide the processed audio signal 406. The processed audio signal 406 may be a processed version of the audio signal 106 associated with full-band audio. Additionally, the processed audio signal 406 may correspond to the reconstructed full-band audio signal 108 referenced herein.

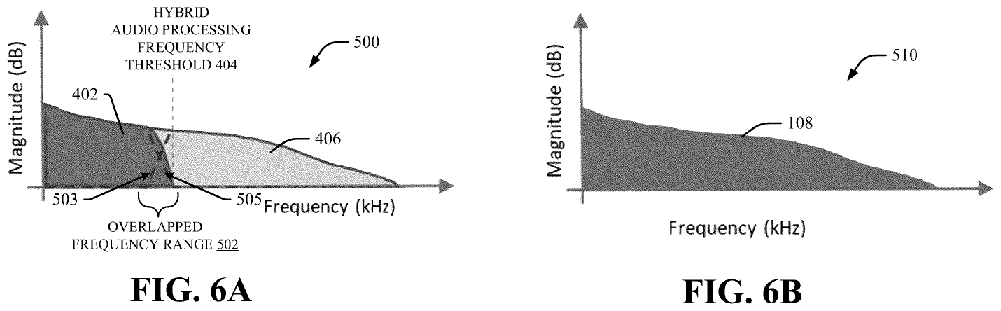

FIG. 6A depicts a graph 500 resulting from the application of a frequency characteristics output to an audio signal based on an overlapped frequency range, according to one or more embodiments of the present disclosure. The graph 500 includes the first frequency portion 402 and the processed audio signal 406. The graph 500 also includes an overlapped frequency range 502 as shown. The overlapped frequency range 502 is defined proximate to the hybrid audio processing frequency threshold 404. For example, the overlapped frequency range 502 may include a portion of audio data associated with the first frequency portion 402 and a portion of audio data associated with the processed audio signal 406. In certain embodiments, the portion of audio data associated with the processed audio signal 406 may correspond to a reverb audio portion of the processed audio signal 406 and the portion of audio data associated with the first frequency portion 402 may correspond to a dereverberated audio portion.

The overlapped frequency range 502 may be employed to execute a ramping up window process 503 for a full-band reverb audio signal and ramping down window process 505 for a lower band dereverberated audio signal. The overlapped frequency range 502 may be selected or identified as a portion of audio data to undergo the ramping up window process 503 and/or the ramping down window process 505 to blend reverb audio data and dereverberated audio data. For example, the ramping up window process 503 may be configured to incrementally increase a magnitude of respective frequency-domain bins within the overlapped frequency range 502. The ramping up window process 503 may begin at a lower frequency value of the overlapped frequency range 502 and may end at a higher frequency value of the overlapped frequency range 502. Further, the ramping down window process 505 may be configured to incrementally decrease a magnitude of respective frequency-domain bins within the overlapped frequency range 502. The ramping down window process 505 may begin at a higher frequency value of the overlapped frequency range 502 and may end at a lower frequency value of the overlapped frequency range 502.

FIG. 6B depicts a graph 510 of a reconstructed full-band audio signal after execution of one or more DSP processes, according to one or more embodiments of the present disclosure. The graph 510 includes a magnitude versus frequency representation of the reconstructed full-band audio signal 108. The reconstructed full-band audio signal 108 may be a modified version of the processed audio signal 406 after execution of one or more DSP processes. That is, the reconstructed full-band audio signal 108 may be a modified version of the processed audio signal 406 after execution of the one or more audio ramping window processes associated with the overlapped frequency range 502 such that an audio band related to the audio signal 106 is maintained in the reconstructed full-band audio signal 108.

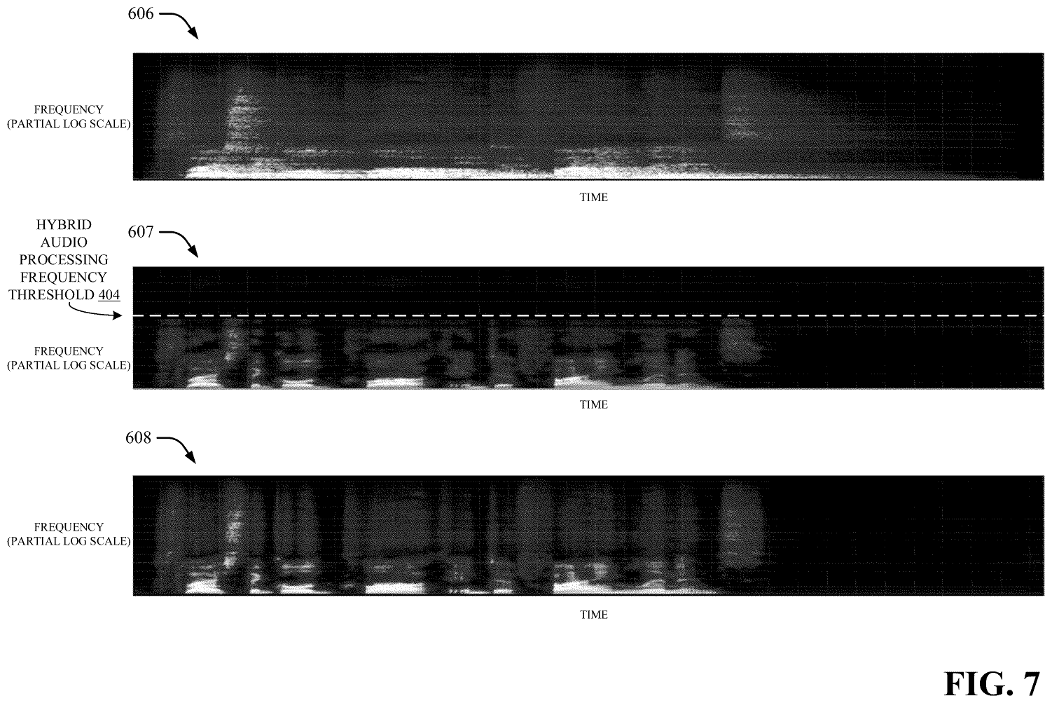

FIG. 7 illustrates a spectrogram comparison of an audio signal and a reconstructed full-band audio signal associated with full-band audio reconstruction, according to one or more embodiments of the present disclosure. For example, FIG. 7 includes a spectrogram 606 that represents the audio signal 106, a spectrogram 607 that represents filtered audio as determined based on the ML model 114, and a spectrogram 608 that represents the reconstructed full-band audio signal 108. As will be apparent to one of ordinary skill in the art, the spectrogram 606 illustrates sound having undesirable sound characteristics (e.g., noise, reverberation, or other undesirable audio artifacts) in the audio signal 106.

The spectrogram 607 illustrates filtering of the undesirable sound based on application of a machine learning model (e.g., ML model 114 of FIG. 1) to a first frequency portion of the audio signal 106 below the hybrid audio processing frequency threshold 404. In a non-limiting example, the hybrid audio processing frequency threshold 404 corresponds to an 8 kHz hybrid audio processing frequency threshold. However, it is to be appreciated that, in certain embodiments, the hybrid audio processing frequency threshold 404 may correspond to a different frequency threshold value.

The spectrogram 608 illustrates reconstructed audio of the audio signal 106 (e.g., the reconstructed full-band audio signal 108) with the undesirable sound being removed or minimized. More particularly, spectrogram 608 illustrates a reconstructed full-band audio signal 108 that was generated by application of DSP operations that are informed by audio characteristics identified when an ML model was applied to a first portion of the audio signal defined below a hybrid audio processing frequency threshold. As illustrated by the spectrogram 608, a frequency range of the audio signal 106 may be maintained in the reconstructed full-band audio signal 108 while also removing undesirable sound from the audio signal 106.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

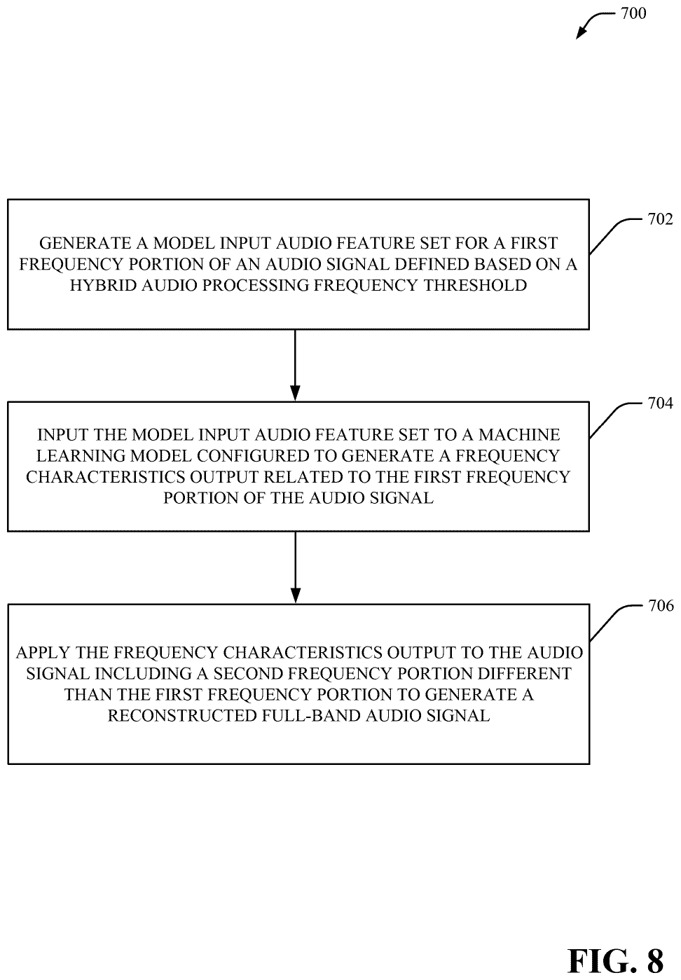

FIG. 8 is a flowchart diagram of an example process 700, for providing hybrid audio signal processing using a combination of machine learning and digital signal processing, in accordance with, for example, the audio signal processing apparatus 152 illustrated in FIG. 2. Via the various operations of the process 700, the audio signal processing apparatus 152 may enhance quality and/or reliability of audio associated with an audio signal. The process 700 begins at operation 702 that generates (e.g., by the first frequency processing engine 110) a model input audio feature set for a first frequency portion of an audio signal defined based on a hybrid audio processing frequency threshold. For example, a first frequency processing engine (e.g., 110) may generate the model input audio feature set (e.g., 202). The model input audio feature set may be generated based on one or more measurements and/or analysis of audio characteristics related to the first frequency portion of the audio signal. For example, the model input audio features may represent physical features and/or perceptual features related to the first frequency portion of the audio signal. The physical features and/or perceptual features may comprise: one or more: audio spectrum features, magnitude features, phase features, pitch features, harmonic features, MFCC features, performance features, performance sequencer features, tempo features, time signature features, and/or other types of features associated with the first frequency portion of the audio signal.

The process 700 also includes an operation 704 that inputs (e.g., by the first frequency processing engine 110) the model input audio feature set to a machine learning model configured to generate a frequency characteristics output related to the first frequency portion of the audio signal. For example, audio signal processing apparatus 902 may input the model input audio feature set (e.g., 202) to a machine learning model (e.g., 114) that is configured to generate a frequency characteristics output (e.g., 204). The machine learning model may be a DNN model, a GAN model, a RNN model, or another type of machine learning model associated with machine learning or deep learning. The machine learning model may also provide audio characteristic insights and/or predictions related to the model input audio feature set to generate the frequency characteristics output. For example, the audio characteristic insights and/or predictions may be related to audio characteristics, frequency-based characteristics, temporal characteristics, magnitude characteristics, attenuation characteristics, denoising characteristics, dereverberation characteristics, filtering characteristics, generative audio characteristics, and/or other characteristics of the model input audio feature set. In some examples, the audio characteristic insights and/or predictions may be related to scaling of magnitude and/or other frequency characteristic modifications related to the first frequency portion of an audio signal to provide denoising, dereverberation, and/or other filtering of undesirable sound associated with the first frequency portion of an audio signal. In some examples, the process 700 includes training the machine learning model during a training phase based on training data extracted from frequency portions of prior audio signals. In some examples, the frequency portions correspond to frequencies of the first frequency portion. The process 700 also includes an operation 706 that applies (e.g., by the second frequency processing engine 112) the frequency characteristics output to the audio signal including a second frequency portion different than the first frequency portion to generate a reconstructed full-band audio signal. For example, the frequency characteristics output may be applied to the second frequency portion of the audio signal to generate digitized audio data. The digitized audio data may also be transformed into a time domain format to generate the reconstructed full-band audio signal. In various embodiments, the frequency characteristics output may be applied to the second frequency portion of the audio signal based on one or more DSP techniques related to, but not limited to, upsampling, audio framing, power calculations, magnitude alignment, audio band scaling, and/or audio band ramping with respect to the second frequency portion of the audio signal. In some examples, the process 700 includes outputting the reconstructed full-band audio signal to an audio output device. The audio output device may include headphones, earphones, one or more speakers, a digital conference system, a wireless conference unit, an audio workstation device, an augmented reality device, a virtual reality device, a recording device, or another type of audio output device.

In some examples, the first frequency portion is a lower frequency portion defined below the hybrid audio processing frequency threshold, and the second frequency portion is a higher frequency portion defined above the hybrid audio processing frequency threshold.

Alternatively, in some examples, the first frequency portion is a higher frequency portion defined above the hybrid audio processing frequency threshold, and the second frequency portion is a lower frequency portion defined below the hybrid audio processing frequency threshold.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

Clause 1. An audio signal processing apparatus comprising at least one processor and a memory storing instructions that are operable, when executed by the processor, to cause the audio signal processing apparatus to: generate a model input audio feature set for a first frequency portion of an audio signal defined based on a hybrid audio processing frequency threshold.

Clause 2. The audio signal processing apparatus of clause 1, wherein the instructions are further operable to cause the audio signal processing apparatus to: input the model input audio feature set to a machine learning model configured to generate a frequency characteristics output related to the first frequency portion of the audio signal.

Clause 3. The audio signal processing apparatus of any one of the foregoing clauses, wherein the instructions are further operable to cause the audio signal processing apparatus to: apply the frequency characteristics output to at least a second frequency portion of the audio signal to generate a reconstructed full-band audio signal, wherein the second frequency portion is different from the first frequency portion.

Clause 4. The audio signal processing apparatus of any one of the foregoing clauses, wherein the instructions are further operable to cause the audio signal processing apparatus to: generate, based on a magnitude of the first frequency portion and the model input audio feature set, a scaled magnitude of the first frequency portion of the audio signal.

Clause 5. The audio signal processing apparatus of any one of the foregoing clauses, wherein the instructions are further operable to cause the audio signal processing apparatus to: calculate a spectrum power ratio for an overlapped frequency range proximate to the hybrid audio processing frequency threshold.

Clause 6. The audio signal processing apparatus of any one of the foregoing clauses, wherein the instructions are further operable to cause the audio signal processing apparatus to: based on the spectrum power ratio, apply the frequency characteristics output to the audio signal.

Clause 7. The audio signal processing apparatus of any one of the foregoing clauses, wherein the instructions are further operable to cause the audio signal processing apparatus to: using one or more digital signal processing (DSP) techniques, apply the frequency characteristics output to the second frequency portion of the audio signal.

Clause 8. The audio signal processing apparatus of any one of the foregoing clauses, wherein the instructions are further operable to cause the audio signal processing apparatus to: generate the model input audio feature set based on a digital transform of the first frequency portion of the audio signal, wherein the digital transform is defined based on the hybrid audio processing frequency threshold.

Clause 9. The audio signal processing apparatus of any one of the foregoing clauses, wherein the instructions are further operable to cause the audio signal processing apparatus to: apply the frequency characteristics output to the second frequency portion of the audio signal to generate digitized audio data.

Clause 10. The audio signal processing apparatus of any one of the foregoing clauses, wherein the instructions are further operable to cause the audio signal processing apparatus to: transform the digitized audio data into a time domain format to generate the reconstructed full-band audio signal.

Clause 11. The audio signal processing apparatus of any one of the foregoing clauses, wherein the instructions are further operable to cause the audio signal processing apparatus to: select the hybrid audio processing frequency threshold from a plurality of hybrid audio processing frequency thresholds, wherein each hybrid audio processing frequency threshold of the plurality of hybrid audio processing frequency thresholds is based on a type of audio processing associated with the machine learning model.

Clause 12. The audio signal processing apparatus of any one of the foregoing clauses, wherein the machine learning model is configured for dereverberation audio processing.

Clause 13. The audio signal processing apparatus of any one of the foregoing clauses, wherein the machine learning model is configured for denoising.

Clause 14. The audio signal processing apparatus of any one of the foregoing clauses, wherein the audio signal is associated with reverberated audio data and the reconstructed full-band audio signal is associated with dereverberated audio data.

Clause 15. The audio signal processing apparatus of any one of the foregoing clauses, wherein the first frequency portion is a lower frequency portion defined below the hybrid audio processing frequency threshold, and the second frequency portion is a higher frequency portion defined above the hybrid audio processing frequency threshold.

Clause 16. The audio signal processing apparatus of any one of the foregoing clauses, wherein the first frequency portion is a higher frequency portion defined above the hybrid audio processing frequency threshold, and the second frequency portion is a lower frequency portion defined below the hybrid audio processing frequency threshold.

Clause 17. The audio signal processing apparatus of any one of the foregoing clauses, wherein the machine learning model is a deep neural network (DNN) model.

Clause 18. The audio signal processing apparatus of any one of the foregoing clauses, wherein the machine learning model is a digital signal processing (DSP) model.

Clause 19. The audio signal processing apparatus of any one of the foregoing clauses, wherein the machine learning model is trained during a training phase based on training data extracted from frequency portions of prior audio signals.

Clause 20. The audio signal processing apparatus of any one of the foregoing clauses, wherein the frequency portions correspond to frequencies of the first frequency portion.

Clause 21. The audio signal processing apparatus of any one of the foregoing clauses, wherein the hybrid audio processing frequency threshold is one of 500 Hz, 4 kHz, or 8 kHz.

Clause 22. The audio signal processing apparatus of any one of the foregoing clauses, wherein the instructions are further operable to cause the audio signal processing apparatus to: output the reconstructed full-band audio signal to an audio output device.

Clause 23. A computer-implemented method comprising steps in accordance with any one of the foregoing clauses.

Clause 24. A computer program product, stored on a computer readable medium, comprising instructions that, when executed by one or more processors of the audio signal processing apparatus, cause the one or more processors to perform one or more operations related to any one of the foregoing clauses.

Clause 25. An audio signal processing apparatus comprising at least one processor and a memory storing instructions that are operable, when executed by the processor, to cause the audio signal processing apparatus to: generate a model input audio feature set for a first frequency band of an audio signal.

Clause 26. The audio signal processing apparatus of clause 25, wherein the instructions are further operable to cause the audio signal processing apparatus to: input the model input audio feature set to a machine learning model configured to generate a frequency characteristics output related to the first frequency band.

Clause 27. The audio signal processing apparatus of any one of the foregoing clauses, wherein the instructions are further operable to cause the audio signal processing apparatus to: apply the frequency characteristics output to at least a second frequency portion of the audio signal to generate a reconstructed full-band audio signal.

Clause 28. The audio signal processing apparatus of any one of the foregoing clauses, wherein the instructions are further operable to cause the audio signal processing apparatus to: output the reconstructed full-band audio signal to an audio output device.

Clause 29. A computer-implemented method comprising steps in accordance with any one of the foregoing clauses.

Clause 30. A computer program product, stored on a computer readable medium, comprising instructions that, when executed by one or more processors of the audio signal processing apparatus, cause the one or more processors to perform one or more operations related to any one of the foregoing clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An audio signal processing apparatus comprising at least one processor and a memory storing instructions that are operable, when executed by the processor, to cause the audio signal processing apparatus to:
generate a model input audio feature set for a first frequency portion of an audio signal defined based on a hybrid audio processing frequency threshold;
input the model input audio feature set to a machine learning model configured to generate a frequency characteristics output related to the first frequency portion of the audio signal;
apply the frequency characteristics output to at least a second frequency portion of the audio signal to generate a reconstructed full-band audio signal, wherein the second frequency portion is different from the first frequency portion; and
output the reconstructed full-band audio signal to an audio output device.

2. The audio signal processing apparatus of claim 1, wherein the instructions are further operable to cause the audio signal processing apparatus to:
generate, based on a magnitude of the first frequency portion and the model input audio feature set, a scaled magnitude of the first frequency portion of the audio signal.

3. The audio signal processing apparatus of claim 1, wherein the instructions are further operable to cause the audio signal processing apparatus to:
calculate a spectrum power ratio for an overlapped frequency range proximate to the hybrid audio processing frequency threshold; and
based on the spectrum power ratio, apply the frequency characteristics output to the audio signal.

4. The audio signal processing apparatus of claim 1, wherein the instructions are further operable to cause the audio signal processing apparatus to:
using one or more digital signal processing (DSP) techniques, apply the frequency characteristics output to the second frequency portion of the audio signal.

5. The audio signal processing apparatus of claim 1, wherein the instructions are further operable to cause the audio signal processing apparatus to:
generate the model input audio feature set based on a digital transform of the first frequency portion of the audio signal, wherein the digital transform is defined based on the hybrid audio processing frequency threshold.

6. The audio signal processing apparatus of claim 1, wherein the instructions are further operable to cause the audio signal processing apparatus to:
apply the frequency characteristics output to the second frequency portion of the audio signal to generate digitized audio data; and
transform the digitized audio data into a time domain format to generate the reconstructed full-band audio signal.

7. The audio signal processing apparatus of claim 1, wherein the instructions are further operable to cause the audio signal processing apparatus to:
select the hybrid audio processing frequency threshold from a plurality of hybrid audio processing frequency thresholds, wherein each hybrid audio processing frequency threshold of the plurality of hybrid audio processing frequency thresholds is based on a type of audio processing associated with the machine learning model.

8. The audio signal processing apparatus of claim 1, wherein the first frequency portion is a lower frequency portion defined below the hybrid audio processing frequency threshold, and the second frequency portion is a higher frequency portion defined above the hybrid audio processing frequency threshold.

9. The audio signal processing apparatus of claim 1, wherein the first frequency portion is a higher frequency portion defined above the hybrid audio processing frequency threshold, and the second frequency portion is a lower frequency portion defined below the hybrid audio processing frequency threshold.

10. The audio signal processing apparatus of claim 1, wherein the machine learning model is trained during a training phase based on training data extracted from frequency portions of prior audio signals, wherein the frequency portions correspond to frequencies of the first frequency portion.

11. The audio signal processing apparatus of claim 1, wherein the hybrid audio processing frequency threshold is one of 500 Hz, 4 kHz, or 8 kHz.

12. A computer-implemented method, comprising:
generating a model input audio feature set for a first frequency portion of an audio signal defined based on a hybrid audio processing frequency threshold;
inputting the model input audio feature set to a machine learning model configured to generate a frequency characteristics output related to the first frequency portion of the audio signal;
applying the frequency characteristics output to at least a second frequency portion of the audio signal to generate a reconstructed full-band audio signal, wherein the second frequency portion is different from the first frequency portion; and
outputting the reconstructed full-band audio signal to an audio output device.

13. The computer-implemented method of claim 12, further comprising:
generating, based on a magnitude of the first frequency portion and the model input audio feature set, a scaled magnitude of the first frequency portion of the audio signal.

14. The computer-implemented method of claim 12, further comprising:
calculating a spectrum power ratio for an overlapped frequency range proximate to the hybrid audio processing frequency threshold; and
applying the frequency characteristics output to the audio signal based on the spectrum power ratio.

15. The computer-implemented method of claim 12, further comprising:
applying the frequency characteristics output to the second frequency portion of the audio signal using one or more digital signal processing (DSP) techniques.

16. The computer-implemented method of claim 12, further comprising:
generating the model input audio feature set based on a digital transform of the first frequency portion of the audio signal, wherein the digital transform is defined based on the hybrid audio processing frequency threshold.

17. The computer-implemented method of claim 12, further comprising:
applying the frequency characteristics output to the second frequency portion of the audio signal to generate digitized audio data; and
transforming the digitized audio data into a time domain format to generate the reconstructed full-band audio signal.

18. The computer-implemented method of claim 12, further comprising:
selecting the hybrid audio processing frequency threshold from a plurality of hybrid audio processing frequency thresholds, wherein each hybrid audio processing frequency threshold of the plurality of hybrid audio processing frequency thresholds is based on a type of audio processing associated with the machine learning model.

19. The computer-implemented method of claim 12, further comprising:
training the machine learning model during a training phase based on training data extracted from frequency portions of prior audio signals, wherein the frequency portions correspond to frequencies of the first frequency portion.

20. A computer program product, stored on a computer readable medium, comprising instructions that, when executed by one or more processors of an audio signal processing apparatus, cause the one or more processors to:
generate a model input audio feature set for a first frequency portion of an audio signal defined based on a hybrid audio processing frequency threshold;
input the model input audio feature set to a machine learning model configured to generate a frequency characteristics output related to the first frequency portion of the audio signal;
apply the frequency characteristics output to at least a second frequency portion of the audio signal to generate a reconstructed full-band audio signal, wherein the second frequency portion is different from the first frequency portion; and
output the reconstructed full-band audio signal to an audio output device.
